(19) United States
(12) Patent Application Publication
(10) Pub. No.: US 2026/0194954 A1
(43) Pub. Date: Jul. 9, 2026

(54) INTERRUPTIBLE LOAD SHARING BUS FOR GREATER SYSTEM POWER EFFICIENCY

(71) Applicant: Lenovo Global Technology (UnitedStates) Inc., Morrisville, NC (US)

(72) Inventors: Douglas Evans, Cary, NC (US); Brian C Totten, Durham, NC (US); Jose I Rojas, Durham, NC (US); Kishore Eswaran, Morrisville, NC (US)

(21) Appl. No.: 19/011,099

(22) Filed: Jan. 6, 2025

(51) Int. Cl. G06F 1/30; G06F 1/3234

(52) U.S. Cl. CPC G06F 1/305; G06F 1/3243

(57) ABSTRACT

An apparatus includes first and second power supply units connected in parallel to supply power to a system load, a load sharing bus extending between the first and second power supply units, an electronic switch positioned in the load sharing bus between the first and second power supply units, and a system controller having a control line connected to the electronic switch to control the electronic switch to be in a closed condition or an open condition. The closed condition of the electronic switch connects the first power supply unit to the load sharing bus and the open condition of the electronic switch disconnects the first power supply unit from the load sharing bus. The first and second power supply units are configured to supply power to the system load regardless of whether the electronic switch is in the closed condition or in the open condition.

### BACKGROUND

The present disclosure relates to a system, method and computer program product for controlling the operation of multiple power supplies operating in parallel.

### BACKGROUND OF THE RELATED ART

Modern servers and other electronic systems often require several power supplies (PSUs) operating in parallel to mutually power the system. To balance the system load between power supply units, there is often a current/load sharing control loop or bus, with a current utilization signal (“ISHARE”) shared amongst the power supplies. The ISHARE signal helps to balance the load among the power supply units, which is useful for avoiding a single power supply unit from taking most of the load and exceeding its power rating. In systems having multiple power supplies units, ISHARE works to continuously balance the load across all power supply units under all operating conditions and operating ranges. Accordingly, the use of the ISHARE signal is effective in preventing each power supply unit for exceeding power delivery rating.

### BRIEF SUMMARY

Some embodiments provide an apparatus comprising first and second power supply units connected in parallel to supply power to a system load, a load sharing bus extending between the first and second power supply units, an electronic switch positioned in the load sharing bus between the first and second power supply units, and a system controller having a control line connected to the electronic switch to control the electronic switch to be in a closed condition or an open condition. The closed condition of the electronic switch connects the first power supply unit to the load sharing bus and the open condition of the electronic switch disconnects the first power supply unit from the load sharing bus. The first and second power supply units are configured to supply power to the system load regardless of whether the electronic switch is in the closed condition or in the open condition.

Some embodiments provide a computer program product comprising a non-transitory computer readable storage medium and program instructions embodied therein, the program instructions being configured to be executable by a processor to cause the processor to perform various operations. The operations comprise controlling a first electronic switch positioned in a load sharing bus to an open condition that prevents communication of a load sharing signal between first and second power supply units through the first electronic switch, wherein the load sharing bus extends between first and second power supply units operating in parallel to supply power to a system load, and wherein the power supply units both supply power to the system load when the first electronic switch is in the open condition. The operations further comprise controlling the first electronic switch positioned in the load sharing bus to a closed condition that enables communication of the load sharing signal between the first and second power supply units through the first electronic switch, wherein the first and second power supply units both operate in a load balancing mode when the first electronic switch is in the closed condition, and wherein the power supply units both supply power to the system load when the first electronic switch is in the closed condition.

### BRIEF DESCRIPTION OF THE SEVERAL VIEWS OF THE DRAWINGS

FIG. 1 is a schematic diagram of multiple power supplies connected to a load sharing bus that includes electronic switches positioned within the load sharing bus.

FIG. 2 is a schematic diagram of three power supply units (PSU1, PSU2 and PSU3) that have been disconnected from the load sharing bus by the operation of opening the electronic switches.

FIG. 3 is a schematic diagram of the three power supply units (PSU1, PSU2 and PSU3) previously shown in FIG. 2 after the power supply units have been reconnected to the load sharing bus by the operation of closing the electronic switches.

FIG. 4 is a schematic diagram of a system including four power supply units (PSU1, PSU2, PSU3 and PSU4) including two separate load sharing buses.

FIG. 5 is a diagram of an electronic switch in the form of a metal-oxide-semiconductor field-effect transistor (MOSFET).

FIG. 6 is a diagram of two power supply units including load share controllers interfacing with the load sharing bus.

FIG. 7 is a diagram of a system having the electronic switches located within the power supply units.

### DETAILED DESCRIPTION

Some embodiments provide an apparatus comprising first and second power supply units connected in parallel to supply power to a system load, a load sharing bus extending between the first and second power supply units, an electronic switch positioned in the load sharing bus between the first and second power supply units, and a system controller having a control line connected to the electronic switch to control the electronic switch to be in a closed condition or an open condition. The closed condition of the electronic switch connects the first power supply unit to the load sharing bus and the open condition of the electronic switch disconnects the first power supply unit from the load sharing bus. The first and second power supply units are configured to supply power to the system load regardless of whether the electronic switch is in the closed condition or in the open condition.

The apparatus or system may be any of a wide variety of electronic devices or systems that utilize a plurality of power supply units connected in parallel to supply power to the system load. Without limitation, the apparatus may be a server, another type of computer, data storage system, or network communication system. For example, a server chassis may include multiple bays for receiving multiple power supply units and one or more bay or area for support a motherboard the operates on the power supplied by the multiple power supply units. The motherboard may include a number of components that consume power and collectively establish the system load. These components may include one or more central processing units and/or graphics processing units, one or more memory modules, data storage drives, network interface controllers, system management controllers, expansion cards, fans and related components.

The power supply units are connected to an external power source that provides power (input voltage) to the power supply units. Any of the power supply units that are active will convert the input voltage into direct current at one or more output voltages. Although the individual power supply units may ordinarily operate in a voltage regulating mode, multiple power supply units that are connected in parallel to supply power to a system load may be interconnected by a load sharing bus. For example, each power supply unit in the system may include a load share controller that interfaces with the load sharing bus so that every power supply unit connected to the load sharing bus will have access to the load share signal (sometimes referred to as “ISHARE”) on the bus and will supply the same, or generally the same, amount or portion of output current that is being demanded by the system load. Where the power supply unit outputs multiple voltages, such as 1.2 V, 3.3 V and 12 V, the load sharing is typically performed only on the highest output rail. However, the present embodiments of an interruptible load sharing bus could be implemented on any one or more of the output voltages from the power supply units. The load share controller and the load sharing bus enable each of the parallel-connected power supply units to provide an equal amount of the load current. By equalizing the output currents from each of the power supply units, the power supply units will experience substantially uniform thermal stress which may improve the long term reliability of power supply units.

Embodiments disclosed herein recognize that forcing the power supply units to equally share load by producing an equal amount of output current to the system load may not be the most efficient mode of operation for the system. Equal current sharing can force the power supply units' output voltage to compensate higher or force some of the load to be sourced from more remote power supplies. These factors decrease the net power efficiency of the system. It is a technical benefit of the present embodiments that improvements in system power efficiency can be achieved by breaking or interrupting the load sharing bus under certain conditions. Conversely, the system may operate the power supply units with the load sharing bus disconnected under normal operating conditions but reconnect some or all of the power supply units to the load sharing bus in response to certain conditions.

Embodiments provide an interruptible load sharing bus including one or more electronic switches under the control of a controller. While the load sharing bus extends to each of the multiple power supply units in the system, the electronic switches are positioned within the load sharing bus so that the bus can be controllably broken, interrupted or disconnected to prevent the ISHARE signal from one power supply unit to reach another power supply unit. This functionality can be achieved with a discrete network of electronic switches positioned in the path of the load sharing bus. The electronic switches may be located either on a system planar or internal to the PSU while implementing the desired load sharing bus architecture. Each of the switches may be independently controlled to be in an open condition in which the load sharing bus is disconnected or a closed condition in which the load sharing bus is connected in response to a control signal received from the controller. Furthermore, the controller may provide a control signal to one or more of the switches to connect or disconnect an individual power supply unit to/from the load sharing bus, connect or disconnect a group of power supply units to/from the load sharing bus, or connector or disconnect all power supply units to/from the load sharing bus.

The electronic switches are electronically controlled by a control signal from the system controller. In one option, the electronic switch is a field-effect transistor (FET), such as a metal-oxide-semiconductor field-effect transistor (MOSFET). If the electronic switch is a field-effect transistor, the control line may connect an output of the system controller to a gate of the field-effect transistor. Furthermore, the load share controller of the first power supply unit may be connected to a source terminal of the field-effect transistor and the load share controller of the second power supply unit may be connected to the drain terminal of the field-effect transistor, or with the source and drain terminals reversed.

In some embodiments, the one or more electronic switches are secured to a system planar, such as the motherboard or a power interface board (PIB). In other embodiments, the one or more electronic switches may be internal to the power supply unit. Placing the electronic switches inside the power supply units may result in an additional electronic switch, since N power supply units would have N electronic switches rather than having N−1 electronic switches positioned between each of the N power supply units. However, the benefit of placing the electronic switches inside the power supply units includes avoiding redesign of the planar and/or the load sharing bus architecture outside the power supply units. Optionally, the controller may provide an individual control signal to the electronic switch in each power supply unit or the same control signal to the electronic switches in each power supply unit via a direct signal control or via an Inter-Integrated Circuit (I2C) command.

In some embodiments, the system controller may be an integrated circuit selected from a field-programmable gate array (FPGA), baseboard management controller (BMC), application-specific integrated circuit (ASIC). The system controller may control each electronic switch in the load sharing bus as needed to improve overall system efficiency and/or to protect the operation of each power supply unit. For example, the controller may provide the same control signal to all of the electronic switches to disable all load sharing or may provide a separate control signal to each individual electronic switch to selective disable load sharing for any one or more of the power supply units. Furthermore, the system controller may be in communication with each of the power supply units to monitor operating conditions of the power supply units. For example, if one of the power supply units is handling more than an equal share of the system load and issues a high current or high temperature warning while the power supply units are disconnected from the load sharing bus, the controller may detect that warning and reconnect the affected power supply unit or all power supply units to the load sharing bus so that the load on the affected power supply unit is reduced.

In some embodiments, the apparatus may further include a third power supply unit may be connected in parallel with the first and second power supply units to supply power to the system load, where the load sharing bus extends to the third power supply unit. The apparatus may also include a second electronic switch positioned in the load sharing bus between the third power supply unit and the first and second power supply units. Accordingly, the system controller may have a second control line connected to the second electronic switch to control the second electronic switch to be in a closed condition or an open condition. In a manner similar to the first electronic switch, the closed condition of the second electronic switch connects the third power supply unit to the load sharing bus and the open condition of the second electronic switch disconnects the third power supply unit from the load sharing bus. It should be recognized that any number of additional power supply units may be included and may be connected or disconnected from the load sharing bus with an additional electronic switch positioned between the additional power supply unit and the other power supply units. The third power supply unit is configured to supply power to the system load regardless of whether the second electronic switch is in the closed condition or in the open condition.

In some embodiments, the apparatus may include third and fourth power supply units operating in parallel to supply power to the system load. However, a second load sharing bus may extend between the third and fourth power supply units. This is similar to the way that the first load sharing bus extends between the first and second power supply units. The apparatus may further include a second electronic switch positioned in the second load sharing bus between the third and fourth power supply units. The system controller may have a second control line connected to the second electronic switch to control the second electronic switch to be in a closed condition or an open condition, wherein the closed condition of the second electronic switch connects the third power supply unit to the second load sharing bus and the open condition of the second electronic switch disconnects the third power supply unit from the second load sharing bus. Accordingly, the system controller may independently control the whether the first and/or the second load sharing bus is connected or disconnected. However, it should be appreciated that the condition of the of the first and/or second electronic switches controls whether the power supplies are connected to a load sharing bus but does not control whether power supplies are turned on and supplying power to the system load.

Embodiments may be implemented by systems in which the multiple power supply units each have a single voltage output or multiple voltage outputs. Where the power supply units each have multiple voltage outputs, such as a first output supplying 1.2V, a second output supplying 3.3V and a third output supplying 12V, the system may include a load sharing bus for any one or more of the voltage output levels. In one example, the multiple power supply units have three outputs supplying 1.2V, 3.3V and 12V, respectively, and the system includes a first load sharing bus for load balancing the 1.2V output of the power supply units, a second load sharing bus for load balancing the 3.3V output of the power supply units, and a third load sharing bus for load balancing the 12V output of the power supply units. However, the system drawing power from the power supply units will typically demand a significantly greater amount of current from one of the output voltages. Accordingly, the system may include a single load sharing bus for load balancing the output that is in the greatest demand by the system, such as the 12V output, and no load sharing bus for the other output(s), such as the 1.2V and 3.3V outputs. Embodiments may include a load sharing bus for any one or more output that should be load balanced. So, although the embodiments herein may be described in the context of having a single load sharing bus for load balancing a single output voltage or rail of the power supply units, it should be understood that the same load sharing bus architecture and control method may be applied to any number of outputs of the power supply units of a given system.

Some embodiments provide a computer program product comprising a non-transitory computer readable storage medium and program instructions embodied therein, the program instructions being configured to be executable by a processor to cause the processor to perform various operations. The operations comprise controlling a first electronic switch positioned in a load sharing bus to an open condition that prevents communication of a load sharing signal between first and second power supply units through the first electronic switch, wherein the load sharing bus extends between first and second power supply units operating in parallel to supply power to a system load, and wherein the power supply units both supply power to the system load when the first electronic switch is in the open condition. The operations further comprise controlling the first electronic switch positioned in the load sharing bus to a closed condition that enables communication of the load sharing signal between the first and second power supply units through the first electronic switch, wherein the first and second power supply units both operate in a load balancing mode when the first electronic switch is in the closed condition, and wherein the power supply units both supply power to the system load when the first electronic switch is in the closed condition.

In some embodiments of the computer program product, the power efficiency of the two or more power supply units is greater when the first electronic switch is in the open condition than when the first electronic switch is in the closed condition. The amount of the greater power efficiency will vary according to the configuration of the power supply units within the apparatus and whether the system load causes one or more of the power supply units to operate in an efficient or inefficient range.

In some embodiments of the computer program product, the operations may further include monitoring operating conditions of the first and second power supply units and controlling the first electronic switch to change from the open condition to the closed condition in response to: (1) one or more of the power supply units losing its source of power (input voltage), (2) one or more of the power supply units failing, (3) one or more of the power supply units issuing an over current warning, (4) one or more of the power supply units issuing an over-temperature warning, (5) a configuration of the system load changing while the system remains powered on, (6) the total amount of power being consumed by the system load exceeds a predefined power threshold, and/or (7) one or more of the power supply units operating above a predefined threshold. The same or similar operating conditions of the same or different power supply units may be used by the system controller to determine how to control the second electronic switch.

In some embodiments of the computer program product, the operations may further include the first and second power supply units each independently operating in a voltage regulating mode when the first electronic switch is in the open condition.

In some embodiments of the computer program product, the operations may further include controlling a second electronic switch positioned in the load sharing bus between a third power supply unit and the first and second power supply units, wherein the third power supply unit is connected in parallel with the first and second power supply units to supply power to the system load, wherein the second electronic switch is controlled to be in an open condition or a closed condition, and wherein the closed condition of the second electronic switch connects the third power supply unit to the load sharing bus and the open condition of the second electronic switch disconnects the third power supply unit from the load sharing bus.

In some embodiments of the computer program product, the first and second electronic switches are independently controlled. Controlling the first electronic switch to be in the closed condition and the second electronic switch to be in the closed condition causes the first, second and third power supply units to operate in a load balancing mode. Controlling the first electronic switch to be in the closed condition and the second electronic switch to be in the open condition causes the first and second power supply units to operate in a load balancing mode and the third power supply unit to operate in a voltage regulating mode. Controlling the first electronic switch to be in the open condition and the second electronic switch to be in the closed condition causes the second and third power supply units to operate in a load balancing mode and the first power supply unit to operate in a voltage regulating mode. Controlling the first electronic switch to be in the open condition and the second electronic switch to be in the open condition causes the first, second and third power supply units to each independently operate in the voltage regulating mode.

The system controller may cause the one or more of the switches in the load sharing bus to close so that some or all of the power supply units are reconnected to the load sharing bus and resume conventional load sharing. The controller may reconnect the one or more of the power supply units to the load sharing bus in response to system load or other factors like system configuration. The controller preferably receives input from the system enabling the controller to monitor the operation of the system, including the operation of the power supply units individually and/or collectively. It should be recognized that reconnecting the load sharing bus to one or more of the power supply units may result in a reduced power efficiency. So, the controller may avoid reconnecting the load sharing bus to the power supply units unless the system is experiencing conditions that have become more important to address than power efficiency. For example, if the system or any of the power supply units is operating outside of a safe range, then it may be preferable to reconnect load sharing to protect the system and/or an individual component of the system.

In some embodiments, the controller may control the electronic switches to reconnect one or more power supply to the load sharing bus in response to detecting one or more of the following conditions: (1) one or more of the power supply units has lost its source of power (input voltage), (2) one or more of the power supply units has failed, (3) one or more of the power supply units has issued an over current warning (the current exceeds a predetermined percentage above the maximum rating of the power supply unit), (4) one or more of the power supply units has issued an over-temperature warning, (5) the system configuration has changed (i.e., an additional component, such as a PCI card or hard drive, was added to the system while the system was still turned on), (6) the total amount of power being consumed by the server exceeds a predefined power threshold, and/or (7) one or more of the power supply units is operating above a predefined threshold.

The foregoing computer program products may further include program instructions for implementing or initiating any one or more aspects of the methods described herein. Conversely, any of the operations attributed to the computer program products may be included in a method of operating one or more embodiments of the apparatus. Still further, the apparatus may include a processor that performs the program instructions to implement or initiate any one or more operations described herein.

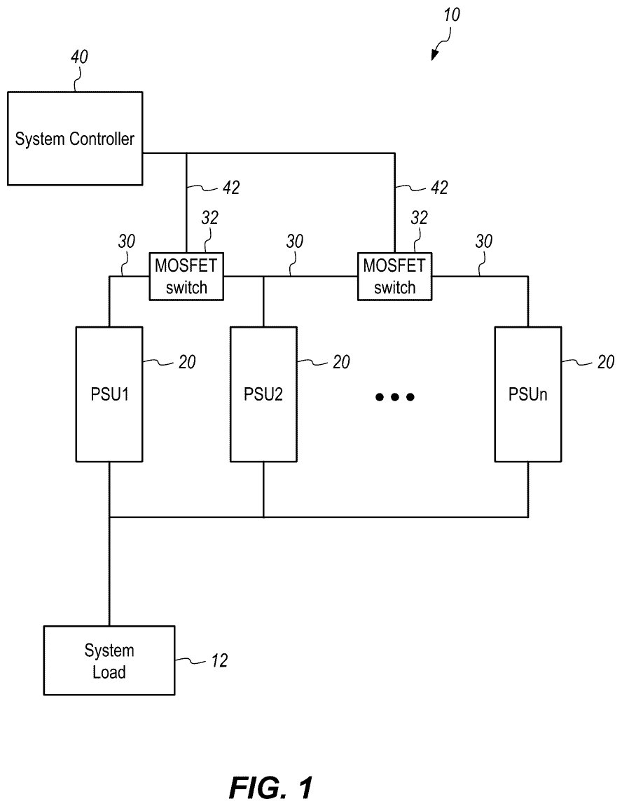

FIG. 1 is a schematic diagram of a system 10 including multiple power supplies 20 connected to a load sharing bus 30 that includes electronic switches 32 positioned within the load sharing bus. The power supply units 20 (PSU₁-PSUₙ) are connected in parallel and have their power outputs directed to supply power to the system load 12. The power supply units 20 would each be connected to a source of power (input voltage), but the source of power and these connections are not shown.

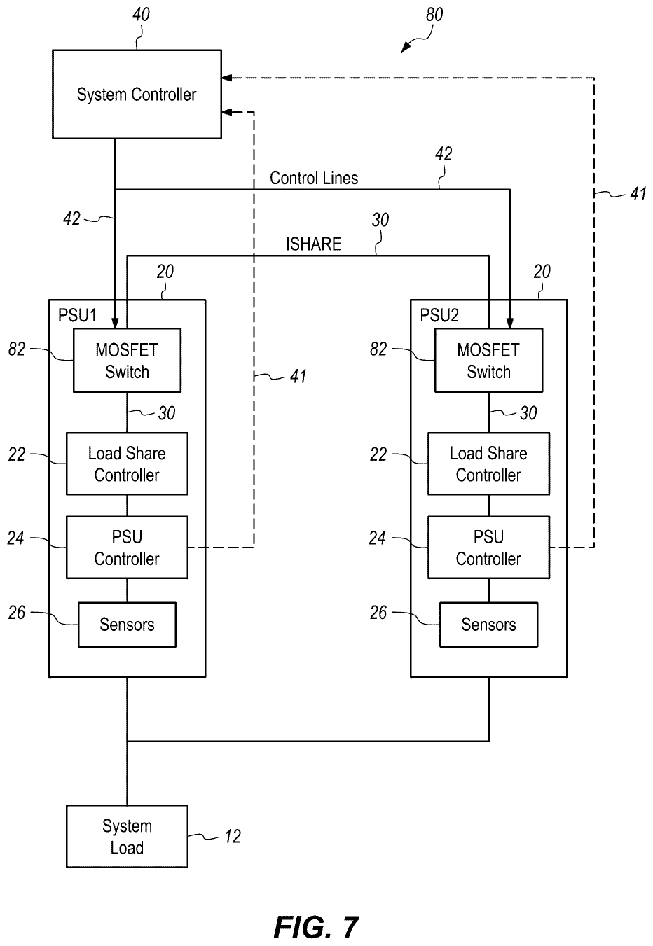

The load sharing bus 30 includes a connection to each of the power supply units 20. For example, each power supply unit 20 may include a load share controller (not shown; but see FIGS. 6 and 7) that interfaces with the load sharing bus 30. The electronic switches 32 are positioned within the load sharing bus 30 and are operated under the control of a system controller 40. Specifically, the system controller 40 may send out a control signal on one or more control lines 42 which may carry the same or different signals to each of the electronic switches 32. The control signal may cause each electronic switch 32 to be either in a closed condition so that load sharing bus is extended through the electronic switch 32 as if the electronic switch were not there or in an open condition so that the load sharing bus is blocked or interrupted at the electronic switch 32 so that no load sharing signals may pass through the electronic switch. As shown, the “n” power supplies may require only “n−1” electronic switches 32 to have the ability to isolate each power supply unit from the load sharing bus and effectively prevent load sharing.

In one option, the system controller may close the left switch 32 and open the right switch 32 so that PSU1 and PSU2 have access to the load sharing bus 30 and will balance their current output to the system load 12, whereas PSUn is isolated or disconnected from the load sharing bus 30 and will not load balance with PSU1 and PSU2. For example, PSU3 may be left to operate in a voltage regulating mode such that the current output of the PSU3 is variable and may be greater than or less than the current output from either or both of PSU1 and PSU2.

In another option, the system controller may open the left switch 32 and close the right switch 32 so that PSU2 and PSUn have access to the load sharing bus 30 and will balance their current output to the system load 12, whereas PSU1 is isolated or disconnected from the load sharing bus 30 and will not load balance with PSU1 and PSU2. For example, PSU1 may be left to operate in a voltage regulating mode such that the current output of the PSU1 is variable and may be greater than or less than the current output from either or both of PSU2 and PSU3. It should be recognized that as the number “n” of power supply units increases, and the number of “n−1” electronic switch increases, there is an increasing number of combinations of open and closed electronic switches that may be implemented by the system controller 40.

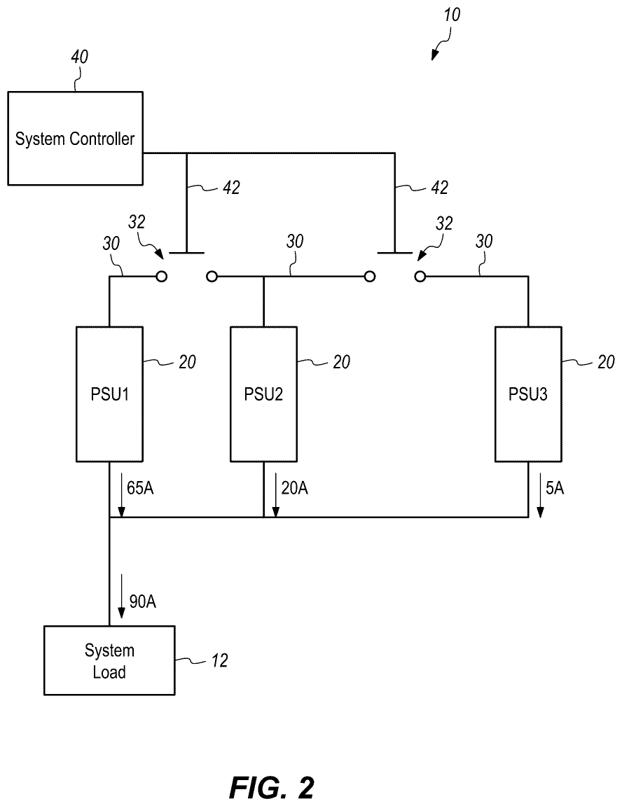

FIG. 2 is a schematic diagram of the system 10 shown in FIG. 1 where there are three power supply units (i.e., “n”=3) and two electronic switches (i.e., “n−1”=2). As shown, the three power supply units 20 (PSU1, PSU2 and PSU3) that have been disconnected from the load sharing bus 30 by the operation of opening the electronic switches. Specifically, with both electronic switches 32 in an open condition, none of the power supply units 20 are able to “share” a load sharing signal over the load sharing bus 30 with any of the other power supply units 20. Without receiving a load sharing signal over the load sharing bus, the three power supply units may exhibit an unbalanced load while operating in a voltage regulating mode. In the specific example of FIG. 2, the first power supply unit (PSU1) is supplying 65 Amps of current, the second power supply unit (PSU2) is supplying 20 Amps of current, and the third power supply unit (PSU3) is supplying only 5 Amps of current. Optionally, these output currents may be provided at a 12 V output to the system load 12. When the electronic switches 32 are open (as illustrated in FIG. 2) and the power supply units 20 are isolated from the load sharing bus 30 and signal (ISHARE signal), the power supply units 20 stop balancing the load current and instead are only concerned with regulating output voltage. This allows one or more power supply units 20 to regulate to a lower output voltage and/or operate in a more efficient operating range, rather than increase their output voltage to force additional current for balancing relative to one or more other power supply units. When load balancing is eliminated, power delivery also favors the power supply units 20 located nearest to the system load 12 (in this case, PSU1), which decreases conduction losses of the system by allowing current to favor the least resistive paths.

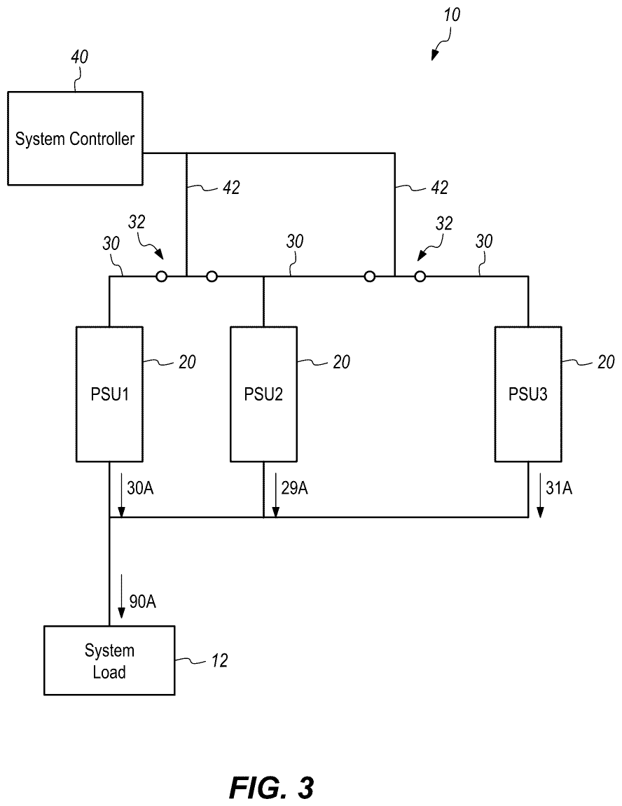

FIG. 3 is a schematic diagram of the of the system 10 shown in FIG. 2 after the three power supply units 20 (PSU1, PSU2 and PSU3) have been reconnected to the load sharing bus 30 by the operation of closing the electronic switches 32. Accordingly, the three power supply units 20 are able to “share” their load sharing signals and closely balance their amount of current output. In the specific example of FIG. 3, the first power supply unit (PSU1) is now supplying 30 Amps of current, the second power supply unit (PSU2) is supplying 29 Amps of current, and the third power supply unit (PSU3) is supplying 31 Amps of current. The total current output from the power supply units with the load sharing bus 30 connected (as shown in FIG. 3) is the same 90 Amps that was supplied by the power supply units with the load sharing bus 30 disconnected (as shown in FIG. 2). However, with the loading sharing bus 30 connected, the load on the first power supply unit (PSU1) is substantially reduced (35 Amps lower), the load on the second power supply unit (PSU2) is somewhat greater (9 Amps higher), and the load on the third power supply unit (PSU3) is substantially greater (26 Amps higher). Accordingly, if the 65 Amp load (see FIG. 2) on the first power supply unit (PSU1) was causing the first power supply unit to exceed its maximum current rating or exceed an over-temperature warning level, then the load sharing bus 30 may be reconnected (see FIG. 3) to distribute the load more evenly across all three of the power supplies 20 and, thereby, to reduce the load on the first power supply unit to a level below its maximum current rating and reduce the temperature of the first power supply unit below its over-temperature warning level.

### Example 1

A motherboard that accommodated two power supply units (PSUs) was connected to an electronic load. Two equivalent model 1300 W PSUs were tested in each of two PSU bays to supply power to the motherboard and the electronic load. When the load sharing bus was disconnected between the two PSUs, the output power efficiency increase of approximately 0.5% was observed (~0.45% at 50 A system load, ~0.54% at 90 A system load). Power savings was achieved regardless of which of the two power supply units were located in which of the two bays, demonstrating that the increase in power efficiency is not dependent upon a dominant power supply unit being installed in a specific location. It should be recognized that the amount efficiency improvements gained by disconnecting load sharing will vary from system to system.

### Example 2

A power interface board (PIB) supporting eight power supply units plus a system load was simulated in Sigrity PowerDC to quantify the percentage reduction in power distribution losses with various combinations of the eight power supply units being disconnected from the load sharing bus. The table below includes the result of three different power supply unit configurations with the load sharing bus connected and disconnected (“Ishare break”). There was a clear and significant increase in power efficiency (i.e., reduction in IR losses) in all three configurations when the load sharing bus was disconnected.

| PSU | PSU Current (A) | | | | | | | | IR Loss |
|---|---|---|---|---|---|---|---|---|---|
| Configuration | PSU1 | PSU2 | PSU3 | PSU4 | PSU5 | PSU6 | PSU7 | PSU8 | Reduction |
| 8x PSUs | 54.3 | 54.3 | 54.3 | 54.3 | 54.3 | 54.3 | 54.3 | 54.3 | — |
| 8x PSUs - Ishare | 19.74 | 22.34 | 43.77 | 47.42 | 56.66 | 59.81 | 88.15 | 100.5 | 3.52% |
| break | | | | | | | | | |
| 6x PSUs | 72.4 | 72.4 | 72.4 | 72.4 | 72.4 | 72.4 | — | — | — |
| (slots 7, 8 | | | | | | | | | |
| uninstalled) | | | | | | | | | |
| 6x PSUs | 23.17 | 45.97 | 63.83 | 104.4 | 99.34 | 97.77 | — | — | 4.90% |
| (slots 7, 8 | | | | | | | | | |
| uninstalled) - | | | | | | | | | |
| Ishare break | | | | | | | | | |
| 6x PSUs | — | — | 72.4 | 72.4 | 72.4 | 72.4 | 72.4 | 72.4 | — |
| (slots 1, 2 | | | | | | | | | |
| uninstalled) | | | | | | | | | |
| 6x PSUs | — | — | 104.6 | 111.3 | 92.42 | 57.04 | 49 | 20.17 | 5.80% |
| (slots 1, 2 | | | | | | | | | |
| uninstalled) - | | | | | | | | | |
| Ishare break | | | | | | | | | |

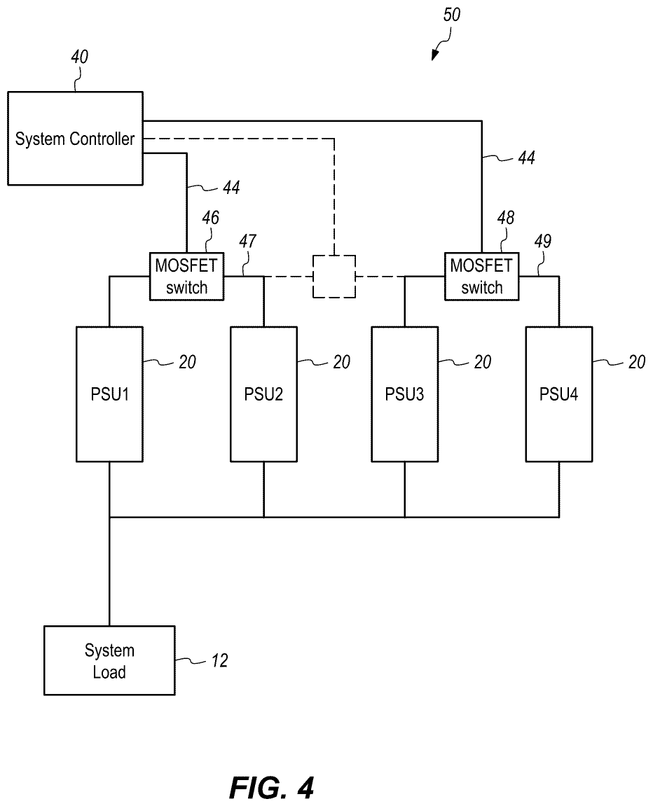

FIG. 4 is a schematic diagram of a system 50 including four power supply units 20 (PSU1, PSU2, PSU3 and PSU4) including two separate load sharing buses 47, 49. A first load sharing bus 47 (on the left side) causes the first and second power supply units (PSU1 and PSU2) to have a balanced current output when the electronic switch 46 is in a closed condition and a second load sharing bus 49 (on the right side) causes the third and fourth power supply units 20 to have a balanced current output when the electronic switch 48 is in a closed condition. However, the load on the first and second power supply units 20 is not necessarily balanced with the load on the third and fourth power supply units 20. Each load sharing bus 47, 49 includes an electronic switch under the control of the system controller 40, such that the system controller may disconnect the first load sharing bus 47 to stop the first and second power supply units 20 from load sharing and/or disconnect the second load sharing bus 49 to stop the third and fourth power supply units 20 from load sharing. It should also be appreciated that a single load sharing bus extending to all four of the power supply units (see dashed lines illustrating the extended load sharing bus and one electronic switch) may be made to operate as two independent load sharing buses 47, 49 by the system controller controlling the central electronic switch (shown as a box in dashed lines) to be in an open condition while controlling the other electronic switches 46, 48 to be in a closed condition. The inclusion and use of electronic switches within the load sharing bus provides significant operational flexibility.

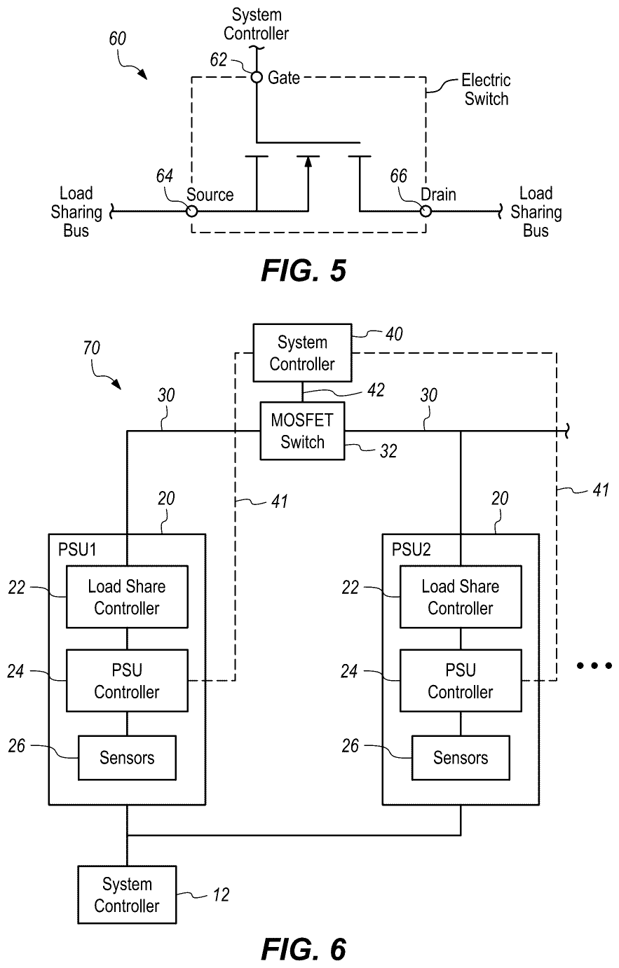

FIG. 5 is a diagram of an electronic switch 60 in the form of a metal-oxide-semiconductor field-effect transistor (MOSFET). The electronic switch 60 includes three terminals: a gate terminal 62, a source terminal 64 and a drain terminal 66. The system controller 40 has a control line 42 that connects to the gate terminal 62. The control signal provided to the gate terminal 62 determines whether the electronic switch 60 is in a closed condition such that electrical signals on the load sharing bus may be transmitted between the source terminal 64 and drain terminal 66 or whether the electronic switch 60 is in an open condition such that electrical signals on the load sharing bus are prevented from being transmitted between the source terminal 64 and drain terminal 66. The electronic switch may be either an n-channel or p-channel MOSFET, or even a different type of FET.

FIG. 6 is a diagram of a system 70 including two power supply units 20 shown in greater detail than in previous Figures. Each power supply unit 20 has a load share controller 22 interfacing with the load sharing bus 30. The load share controller 22 also has a connection to the power supply unit (PSU) controller 24 that controls the output current and voltage of the power supply unit 20. With the electronic switch 32 in a closed condition so that the load sharing bus 30 connected and active, the two load share controllers 22 cause the respective power supply unit controllers 24 to control the current output from the power supply units to the system load 12 to be closely balanced.

The system controller 40 uses the control line 42 to control the electronic switch 32 to be in a closed condition or an open condition. However, the system controller 40 may implement logic to determine whether to close or open the electronic switch 32 based on the current operating conditions of the power supply units 20. Without limitation, the system controller 40 may receive operating conditions or parameters from the power supply unit (PSU) controllers 24 over the communication lines 41, which operating conditions or parameters may be informed by input from various sensors 26 connected to the power supply unit controllers 24. Such sensors 26 may include temperature sensors, current sensors, and the like. The system controller 40 may use the data received from the PSU controllers 24 to make certain decisions and may calculate other parameters based on the received data, such as calculating a total system current output from all of the power supply units. The architecture and operation of system 70 may be implemented regardless of the number of power supply units that are operating in parallel.

FIG. 7 is a diagram of a system 80 having electronic switches 82 located within the power supply units 20. Placing the electronic switches 82 inside the power supply units 20 may result in an additional electronic switch, since N power supply units would have N electronic switches rather than having N−1 electronic switches positioned between each of the N power supply units. However, the benefit of placing the electronic switches 82 inside the power supply units 20 includes avoiding redesign of the planar and/or the load sharing bus architecture outside the power supply units. Optionally, the system controller 40 may provide an individual control signal to the electronic switch 82 in each power supply unit 20 or the same control signal to the electronic switches in each power supply unit via a direct signal control line 42 or via an Inter-Integrated Circuit (I2C) command. Where individual control lines 42 are provided, the system controller 40 may achieve even greater control flexibility over the power supply units 20 since any individual power supply unit may be independently connected or disconnected from the load sharing bus 30 without affecting whether or not any of the other power supply units are connected or disconnect from the load sharing bus. This architecture may be extended to any number of power supply units.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
first and second power supply units connected in parallel to supply power to a system load;
a load sharing bus extending between the first and second power supply units;
an electronic switch positioned in the load sharing bus between the first and second power supply units; and
a system controller having a control line connected to the electronic switch to control the electronic switch to be in a closed condition or an open condition, wherein the closed condition of the electronic switch connects the first power supply unit to the load sharing bus and the open condition of the electronic switch disconnects the first power supply unit from the load sharing bus, and wherein the first and second power supply units are configured to supply power to the system load regardless of whether the electronic switch is in the closed condition or in the open condition.

2. The apparatus of claim 1, wherein the electronic switch is a field-effector transistor.

3. The apparatus of claim 2, wherein the field-effect transistor is a metal-oxide-semiconductor field-effect transistor.

4. The apparatus of claim 2, wherein the control line connects the system controller to a gate of the field-effect transistor.

5. The apparatus of claim 4, wherein each power supply unit includes a load share controller for processing signals on the load sharing bus, wherein the load share controller of the first power supply unit is connected to a source terminal of the field-effect transistor, and wherein the load share controller of the second power supply unit is connected to the drain terminal of the field-effect transistor.

6. The apparatus of claim 1, wherein the electronic switch is secured to a system planar.

7. The apparatus of claim 1, wherein the electronic switch is internal to the first power supply unit.

8. The apparatus of claim 1, wherein each power supply unit includes a load share controller for processing signals on the load sharing bus.

9. The apparatus of claim 1, wherein the system controller is an integrated circuit selected from a field-programmable gate array, baseboard management controller, and application-specific integrated circuit.

10. The apparatus of claim 9, wherein the system controller is in communication with the power supply units to monitor operating conditions of the power supply units.

11. The apparatus of claim 1, further comprising:
a third power supply unit connected in parallel with the first and second power supply units to supply power to the system load, where the load sharing bus extends to the third power supply unit; and
a second electronic switch positioned in the load sharing bus between the third power supply unit and the first and second power supply units, wherein the system controller has a second control line connected to the second electronic switch to control the second electronic switch to be in a closed condition or an open condition, wherein the closed condition of the second electronic switch connects the third power supply unit to the load sharing bus and the open condition of the second electronic switch disconnects the third power supply unit from the load sharing bus, and wherein the third power supply unit is configured to supply power to the system load regardless of whether the second electronic switch is in the closed condition or in the open condition.

12. The apparatus of claim 1, further comprising:
third and fourth power supply units operating in parallel to supply power to the system load;
a second load sharing bus extending between the third and fourth power supply units; and
a second electronic switch positioned in the second load sharing bus between the third and fourth power supply units, wherein the system controller has a second control line connected to the second electronic switch to control the second electronic switch to be in a closed condition or an open condition, wherein the closed condition of the second electronic switch connects the third power supply unit to the second load sharing bus and the open condition of the second electronic switch disconnects the third power supply unit from the second load sharing bus.

13. The apparatus of claim 1, wherein each power supply has a single voltage output to supply power to the system load.

14. The apparatus of claim 1, wherein each power supply has multiple voltage outputs, and wherein the load sharing bus applies load sharing to only one of the multiple voltage outputs.

15. A computer program product comprising a non-transitory computer readable storage medium and program instructions embodied therein, the program instructions being configured to be executable by a processor to cause the processor to perform operations comprising:
controlling a first electronic switch positioned in a load sharing bus to an open condition that prevents communication of a load sharing signal between first and second power supply units through the first electronic switch, wherein the load sharing bus extends between first and second power supply units operating in parallel to supply power to a system load, and wherein the power supply units both supply power to the system load when the first electronic switch is in the open condition; and
controlling the first electronic switch positioned in the load sharing bus to a closed condition that enables communication of the load sharing signal between the first and second power supply units through the first electronic switch, wherein the first and second power supply units both operate in a load balancing mode when the first electronic switch is in the closed condition, and wherein the power supply units both supply power to the system load when the first electronic switch is in the closed condition.

16. The computer program product of claim 15, wherein the power efficiency of the two or more power supply units is greater when the first electronic switch is in the open condition than when the first electronic switch is in the closed condition.

17. The computer program product of claim 15, the operations further comprising:
monitoring operating conditions of the first and second power supply units;
controlling the first electronic switch to change from the open condition to the closed condition in response to: (1) one or more of the power supply units losing its source of power, (2) one or more of the power supply units failing, (3) one or more of the power supply units issuing an over current warning, (4) one or more of the power supply units issuing an over-temperature warning, (5) a configuration of the system load changing while the system remains powered on, (6) the total amount of power being consumed by the system load exceeds a predefined power threshold, and/or (7) one or more of the power supply units operating above a predefined threshold.

18. The computer program product of claim 15, the operations further comprising:
the first and second power supply units each independently operate in a voltage regulating mode when the first electronic switch is in the open condition.

19. The computer program product of claim 15, the operations further comprising:
controlling a second electronic switch positioned in the load sharing bus between a third power supply unit and the first and second power supply units, wherein the third power supply unit is connected in parallel with the first and second power supply units to supply power to the system load, wherein the second electronic switch is controlled to be in an open condition or a closed condition, and wherein the closed condition of the second electronic switch connects the third power supply unit to the load sharing bus and the open condition of the second electronic switch disconnects the third power supply unit from the load sharing bus.

20. The computer program product of claim 15, wherein the first and second electronic switches are independently controlled, wherein controlling the first electronic switch to be in the closed condition and the second electronic switch to be in the closed condition causes the first, second and third power supply units to operate in a load balancing mode, wherein controlling the first electronic switch to be in the closed condition and the second electronic switch to be in the open condition causes the first and second power supply units to operate in a load balancing mode and the third power supply unit to operate in a voltage regulating mode, wherein controlling the first electronic switch to be in the open condition and the second electronic switch to be in the closed condition causes the second and third power supply units to operate in a load balancing mode and the first power supply unit to operate in a voltage regulating mode, wherein controlling the first electronic switch to be in the open condition and the second electronic switch to be in the open condition causes the first, second and third power supply units to each independently operate in the voltage regulating mode.
